(19) United States
(12) Patent Application Publication
(10) Pub. No.: US 2013/0326461 A1
(43) Pub. Date: Dec. 5, 2013

(54) METHOD FOR DETECTING INTERFERENCE IN SPATIAL STRUCTURE

(71) Applicants: Chung-Sheng Ni, Taipei City (TW); Chun-Ying Yang, Taipei City (TW); Chih-Pin Wei, Taipei City (TW); Shiang-Chun Tsau, Taipei City (TW)

(72) Inventors: Chung-Sheng Ni, Taipei City (TW); Chun-Ying Yang, Taipei City (TW); Chih-Pin Wei, Taipei City (TW); Shiang-Chun Tsau, Taipei City (TW)

(73) Assignee: INVENTEC CORPORATION, Taipei City (TW)

(21) Appl. No.: 13/528,321

(22) Filed: Jun. 20, 2012

(30) Foreign Application Priority Data
May 30, 2012 (TW) 101119359

(51) Int. Cl. G06F 17/50

(52) U.S. Cl. 716/136

(57) ABSTRACT

A method for detecting interference in spatial structure is provided. The method includes the following steps. A circuit board is obtained, wherein the circuit board has set a first height limit, and parts of the coordinate areas have set a plurality of second height limits respectively. The second height limits are lower than the first height limit. A Keep-out area is established according to the second height limits of the coordinate areas and the first height limit. The corresponding height of each coordinate area in a substrate-boarded space is compared according to the keep-out area to simulate and determine whether the circuit board is interfered in the substrate-boarded space. Thus, users can immediately check whether interference or clashed in space occurs between the circuit board and the substrate-boarded space.

### CROSS-REFERENCE TO RELATED APPLICATION

This application claims the priority benefit of Taiwan application serial no. 101119359, filed on May 30, 2012. The entirety of the above-mentioned patent application is hereby incorporated by reference herein and made a part of this specification.

### BACKGROUND OF THE INVENTION

1. Field of the Invention

The present invention generally relates to a technique for determining interference of spatial clash, and more particularly to a method for detecting interference in spatial structure between a circuit board and a substrate-board space.

2. Description of Related Art

Along with the rapid advancement of the electronic technology in the recent years, many electronic products with various functions are in the market, and deeply affecting people's work and daily life. For a small electronic product, it usually includes a circuit board and a housing. The circuit board is mainly composed of many electronic components and a circuit board that carries the electronic components. The housing encompasses the motherboard and used to protect the motherboard effectively.

During the process of manufacturing electronic products, in the earlier days, a large amount of inspections by inspectors were performed for the circuit board and the space inside of the housing to prevent interference to ensure the circuit board may be disposed in the housing accurately without spatial clash. In the present days, inspectors may utilize three dimensional graphical drawing software (i.e. AutoCAD) to individually check whether each component on the circuit board are disposed correctly in the housing that has limited space, and protect the components on the circuit board from clashing during the disposition and easily accommodated.

During the aforementioned inspection of spatial clash, due to many small components on the circuit board, the three dimensional graphical drawing software must reads the model parameters of these components on the circuit board and compare these model parameters with the space inside of the housing one by one. For example, the three dimensional graphical drawing software first reads parameters of a certain component, the coordinate and height relationship is obtained from these parameters. After comparing these relationships with the space inside of the housing, the parameters of next component is read. Although there are many identical components on the same circuit board, the three dimensional graphical drawing software only has the capability to read the corresponding components one by one. Hence, a large amount of time is required.

### SUMMARY OF THE INVENTION

A method for detecting interference in spatial structure is provided by the exemplary embodiments of the present invention. A keep-out area is established according to a plurality of coordinate areas divided by the electronic components and a plurality of height limits thereof. The keep-out area is then compared with a substrate-board space to check whether interference and/or spatial clash occur.

The method for detecting interference in spatial structure is provided by the embodiments of the present invention, which includes the following steps: obtaining a circuit board, wherein a first height limit is set for the circuit board, and a plurality of second height limit is set for parts of the coordinate areas in the circuit board respectively, wherein the second height limits are smaller than or equal to the first height limit. The keep-out area is established according the second height limits of the coordinate areas and the first height limit. The corresponding heights of each of the coordinate areas in the substrate-board space are compared according to the keep-out area to simulate and determine whether interference occurs when the circuit board is disposed in the substrate-board space.

According to an embodiment of the present invention, the keep-out area includes a plurality of limited height areas, wherein each of the limited height areas corresponds to one of the coordinate areas in the circuit board. The step for establishing of the keep-out area of the circuit board according to the second height limits of the coordinate areas and the first height limit include the following steps: determining whether each of the coordinate areas in the circuit board has a second height limit correspondingly. When a target coordinate area is set to a second height limit correspondingly, each of the corresponding limited height areas of the target coordinate area is set to the second height limit. When the target coordinate area is not set to a second height limit, each of the corresponding limited height areas of the target coordinate area are set to the first height limit.

According to an embodiment of the present invention, the step for comparing the corresponding heights of each of the coordinate areas in the substrate-board space according to the keep-out area includes the following steps: determining the height set for each of the limited height areas in the keep-out area and the height of the corresponding coordinate areas in the substrate-board space sequentially.

According to an embodiment of the present invention, the simulation and determination of whether an interference occurs when the circuit board is disposed in the substrate-board space include the following steps: when the corresponding height of each of the coordinate areas in the substrate-board space exceeds the keep-out area corresponding to the coordinate areas, determining interference has occurred between the substrate-board space and circuit board, and prompt an fault information.

According to an embodiment of the present invention, the substrate-board space is generated by the formation of a plurality of mechanism components.

According to an embodiment of the present invention, the method for detecting interference further includes, providing a graphical interface to display the keep-out area and the substrate-board space.

According to an embodiment of the present invention, the method for detecting interference further includes, obtaining the first height limit and the second height limits corresponding to the coordinate areas according to a first specification list of the circuit board.

According to an embodiment of the present invention, the method for detecting interference further includes, obtaining the coordinate areas of the substrate-board space according to a second specification list of the substrate-board space.

Base on the above, according to the first height limit and the plurality of second height limits of the circuit board, the keep-out area of the circuit board may be established. Furthermore, the corresponding height of each coordinate area in the substrate-board space in the spatial structure is compared with the keep-out area to simulate and determine whether interference occurs when the circuit board is disposed in the substrate-board space. As a result, the embodiment of the present invention establishes a keep-out area through the coordinate areas divided by the electronic components and the height limits thereof. The keep-out area is utilized to compare with the substrate-board space of the circuit board to check whether interference occurs between the circuit board and substrate-board space.

In order to make the aforementioned and other features and advantages of the present invention comprehensible, several exemplary embodiments accompanied with figures are described in detail below to further describe the disclosure in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram depicts an electronic device according to an embodiment of the present invention.

FIG. 2 is a side view diagram illustrating a spatial structure of the circuit board according to an embodiment of the present invention.

FIG. 3 is a side view diagram illustrating a substrate-board space according to an embodiment of the present invention.

FIG. 4 is a flow chart depicts a method for detecting interference in the spatial structure.

FIG. 5 is a diagram illustrating an interference detection according to an embodiment of the present invention.

FIG. 6 is a flow chart illustrating a method for establishing the keep-out area according to an embodiment of the present invention.

FIG. 7 is a diagram illustrating the method of detecting interference according to an embodiment of the present invention.

### DETAILED DESCRIPTION OF DISCLOSED EMBODIMENTS

A method for detecting interference may be implemented by software and executed in the correlative electronic devices (i.e. a computer or a server), wherein hardware devices may simulate and determine whether a circuit board (i.e. a motherboard) causes interference when disposed in a substrate-boarded space (i.e. space inside of the case). Nevertheless, people skilled in the art may execute or implement the method for detecting interference by adapting firmware procedures or hardware structure for the part of the embodiments, so the disclosure is not limited to the software implementation. In order to make the content of the present invention more comprehensible, exemplary embodiments accompanied with figures are described in detail below.

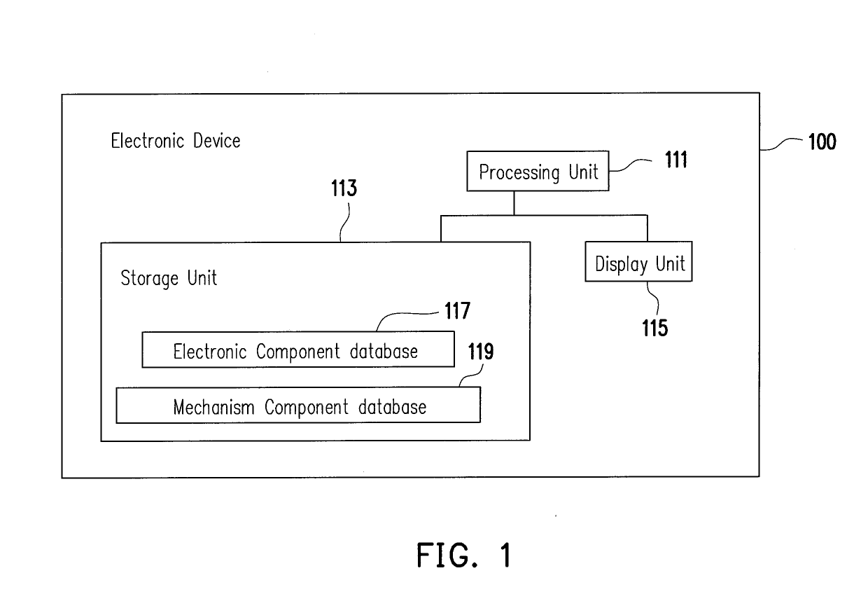

FIG. 1 is a block diagram depicts an electronic device 100 according to an embodiment of the present invention. The method for detecting interference may be implemented on the electronic device 100. The electronic device 100 may be a thin client (TC), a server, a personal computer, a notebook computer, a personal digital assistant (PDA), or other electronic devices. The electronic device 100 is not limited thereto.

The electronic device 100 includes a processing unit 111, a storage unit 113, and a display unit 115, wherein the processing unit 111 is coupled to the storage unit 113 and the display unit 115 respectively. The storage unit 113 may store the required data for the embodiments of the present invention, and the software which is configured to implement the method for detecting interference. In parts of the embodiments, the storage unit 113 may be disposed in the database of a cloud network, and the processing unit 111 may read the data in the storage unit 113 through network or other related communication mechanisms.

The processing unit 111 may be a central processing unit (CPU). The CPU may control the overall operation of the electronic device 100, and implement the method for detecting interference of the present embodiment. The display unit 115 may be a computer screen. The display unit 115 may provide a graphical interface through a computer-aided design (CAD), and display the interference detection results from the processing unit 111 in the graphical interface.

Furthermore, the storage unit 113 may store an electronic component database 117 and a mechanism component database 119. The electronic component database 117 includes preset data of a plurality of electronic components (i.e. capacitors, resistors, and chips), such as related space model, parameters, or other data. For example, the three-dimension spatial model of various electronic components such as height, width, length, position of connection point, quantity, and other related data. A circuit board (i.e. motherboard) designer selects the required components for constructing a motherboard through the electronic component database 117 to design a spatial structure information of the circuit board.

The mechanism component database 119 includes related spatial model and parameters preset by a plurality of mechanism components (i.e. related mechanisms used to construct a housing), a housing designer selects the required parts for constructing the housing through the mechanism component database 119 to design the required structure information of a substrate-board space for disposing the circuit board.

In the present embodiment, the spatial structure information of the circuit board may include a plurality of coordinate areas of the circuit board, wherein each of the coordinate areas may correspond to one or the plurality of mechanism components. The electronic component database 117 in the present embodiment may store a first height limit (that is, a preset maximum height of the overall circuit board) set by the circuit board. At the same time, the electronic component database 117 may store a plurality second height limits (that is, the corresponding maximum heights that may be utilized by parts of the coordinate areas) set respectively by parts of the coordinate areas in the circuit board. Wherein, the second height limits is less than and/or equal to the first height limit The first height limit (the preset maximum height of the overall circuit board) may be set by designers according to the previous experiences or the overall height of the substrate-board space. However, parts of coordinate areas of the circuit board are unable to satisfy the preset maximum height due to the special components (i.e. disposing of hard drives, disc drives, and/or other components) which are disposed in parts of the housing, the second height limits are required to be set respectively for parts of the coordinate areas of the circuit board.

For example, the processing unit 111 may obtain the first height limit of the circuit board and the second height limits corresponding to parts of the coordinate areas from the specification list of the circuit board, and stores the first height limit and the second height limits to the storage unit 113 in the electronic component database 117. Furthermore, the processing unit 111 may display the circuit board on the graphical interface of the display unit 115 according to the spatial structure information of the circuit board.

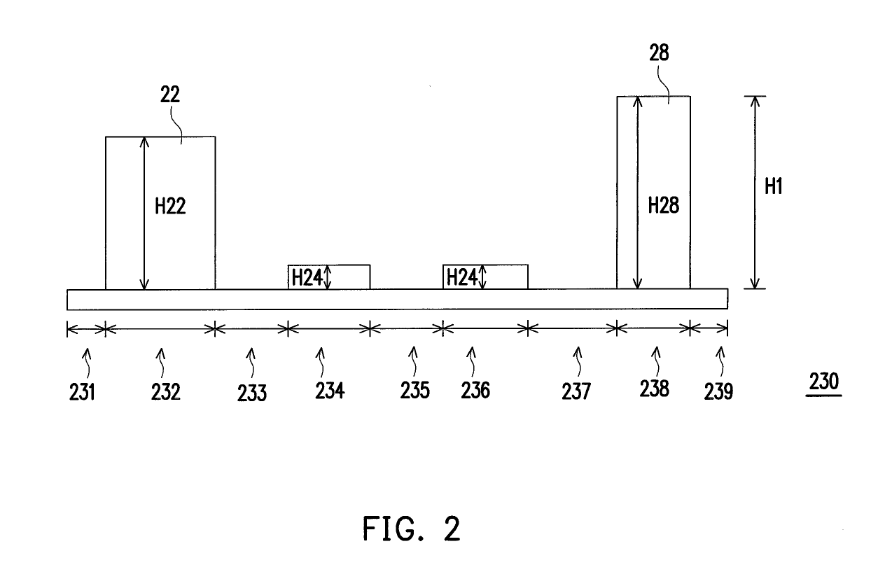

FIG. 2 is a side view diagram illustrating the spatial structure of the circuit board according to an embodiment of the present invention. Referring to FIG. 2, a circuit board 230 includes a plurality of coordinate areas 231˜239, wherein the coordinate areas 232, 234, 236, and 238 correspond to a plurality of spatial areas 22, 24, 26, and 28 that are occupied by mechanism components. For example, if a capacitor is disposed in the coordinate area 232, the spatial area 22 represents the space that is occupied by the capacitor. The circuit board 230 has set the first height limit H1, and parts of the coordinate areas 232, 234, 236, and 238 in the circuit board 230 have respectively set the second height limits H22, H24, H26, and H28, wherein the second height limits H22, H24, H26, and H28 may be less than or equal to the first height limit H1. In the present embodiment, the first height limit H1 is the maximum height of the circuit board 230, that is the second height limit H28 corresponding to the coordinate area 238. In other embodiment, the first height limit H1 may be a height limit set by users. Furthermore, the processing unit 111 may obtain the first height limit H1 of the circuit board 230 and the second height limits H22, H24, H26, and H28 corresponding to parts of the coordinate areas 232, 234, 236, and 238 from the specification list of the circuit board 230, and stores in the electronic component database 117.

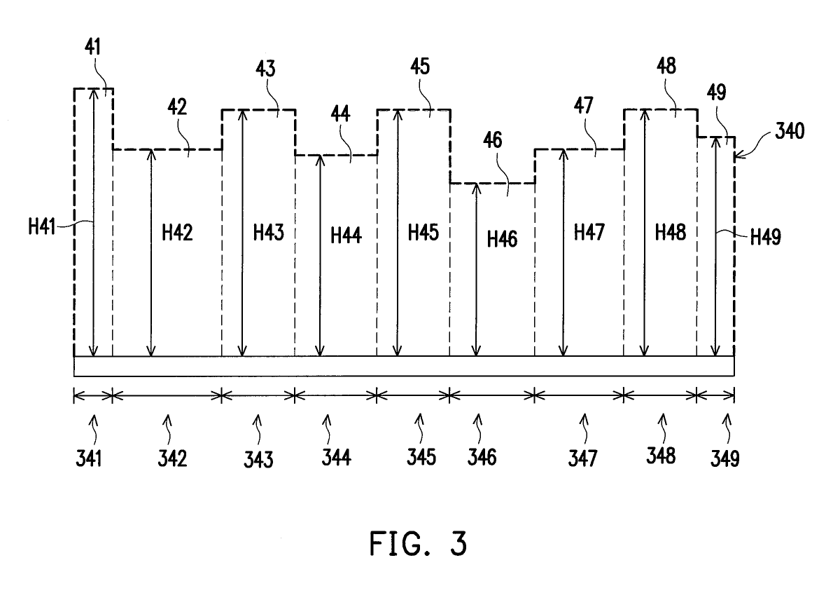

The mechanism component database 119 in the storage unit 113 includes spatial structure information of the substrate-board space. FIG. 3 is a side view diagram illustrating the substrate-board space according to an embodiment of the present invention. Referring to FIG. 3, the spatial structure information of the substrate-board space 340 may include a plurality of coordinate areas 341˜349 of the substrate-board space 340 and a plurality of heights H41˜H49 which correspond to the coordinate areas 341˜349. In details, the substrate-board space 340 may be the spatial areas 41˜49 constructed by the plurality of mechanism components, wherein the coordinate areas 341˜349 of the substrate-board space 340 correspond to the coordinate areas 231˜239 of the circuit substrate 230. For example, if a capacitor is disposed in the coordinate area 342, the spatial area 42 represents the space that is occupied by the capacitor. In addition, the processing unit 111 stores the spatial structure information of the substrate-board space 340 in the mechanism component database 119 according to the specification list of the substrate-board space 340. Furthermore, the processing unit 111 displays the substrate-board space 340 on the graphical interface of the display unit 115 according to the spatial structure information of the substrate-board space 340.

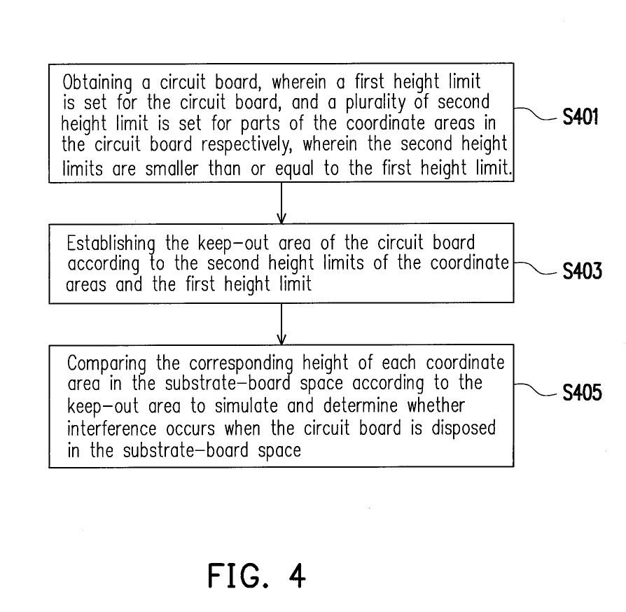

As a result, the processing unit 111 may obtain the spatial structure information of the circuit board 230 and the substrate-board space 340 from the electronic component database 117 and the mechanism component database 119. The processing unit 111 detects whether the circuit board 230 interferes with the substrate-board space 340 in the spatial structure. An electronic device 100 is accompanied with following descriptions to explain the method for detecting interference in spatial structure. FIG. 4 is a flow chart illustrating the method for detecting interference in spatial structure.

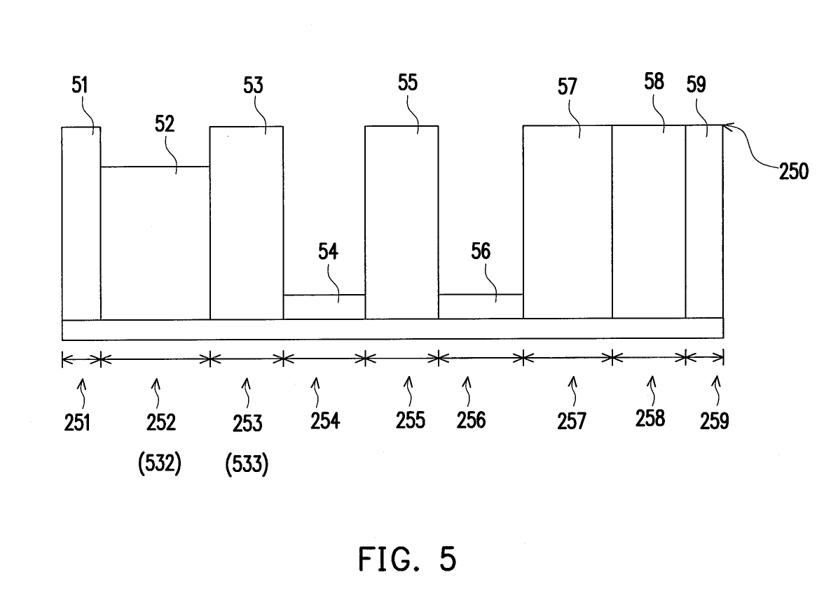

Referring to FIG. 1, FIG. 2, and FIG. 4, in step S401, the processing unit 111 obtains the spatial structure information of the circuit board 230 from the electronic component database 117, wherein the spatial structure information includes the first height limit H1 of the circuit board 230 and the second height limits H22, H24, H26, and H28 which correspond to parts of the coordinate areas 232, 234, 236, and 238. FIG. 2 and FIG. 5 below are used to explain step S401 in detail.

FIG. 5 is a diagram illustrating the interference detection according to an embodiment of the present invention. Referring to FIG. 4, FIG. 2, and FIG. 5, in step S403, the processing unit 111 may establish a keep-out area 250 of circuit board 230 according to the corresponding second height limits H22, H24, H26, and H28 in the coordinate areas 231˜239 and the first height limit H1 of the coordinate areas 231˜239. In FIG. 5, the keep-out area 250 includes a plurality of limited height areas 51˜59, and each of the coordinate areas 251˜259 of the limited height areas 51˜59 corresponds to each of the coordinate areas 231˜239 of the circuit board 230 respectively. The following descriptions explain the process of the establishing the keep-out area 250 in step S403 in detail.

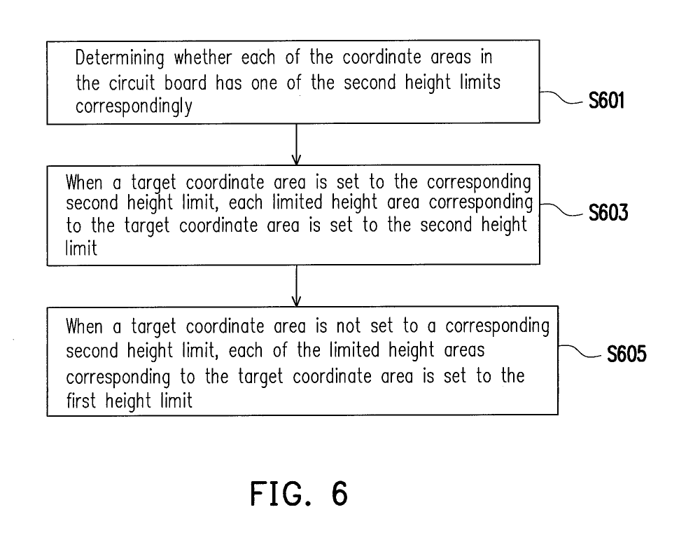

FIG. 6 is a flow chart illustrating a method for establishing the keep-out area according to an embodiment of the present invention. In step S601, the processing unit 111 in FIG. 1 determines whether each of the coordinate areas 231˜239 of the circuit board 230 in FIG. 2 has a corresponding second height limit. For example, the processing unit 111 may determine the second height limits H22, H24, H26, and H28 are set in the coordinate areas 232, 234, 236, and 238. The processing unit 111 may also determine that no corresponding second height limits are set in the coordinate areas 231, 233, 235, 237, and 239.

At this point, the coordinate areas that are determined by the processing unit 111 are named a target coordinate area. To further explain, in step S603, when the target coordinate area determined by the processing unit 111 is set to a corresponding second height limit, the limited height areas of the keep-out area 250 corresponding to the target coordinate area is set to the corresponding second height limit by the processing unit 111. However, when the target coordinate area has no corresponding second height limit, in step S605, the limited height areas of the keep-out area 250 corresponding to the target coordinate area is set to the first height limit H1 by the processing unit 111.

Specifically, in FIG. 5, when the processing unit 111 determines the target coordinate area 532, the limited height of the corresponding limited height area 52 may be set to the second height limit H22. When the processing unit 111 determines the target coordinate area 533, the processing unit 111 sets the limited height of the limited height area 53 corresponding to the target coordinate area 533 to be the first height limit H1, because no second height limit is set for the target coordinate area 533. The limited heights of the remaining limited height areas 51 and 54˜59 may be deduced as described above, hence are not repeated here.

Returning to step S405 and referring to FIG. 3 and FIG. 5, the processing unit 111 may compare the corresponding heights H41˜H49 of each coordinate area 341˜349 in the substrate-board space 340 with the keep-out area 250 to simulate and determine whether interference occurs when the circuit board 230 is disposed in the substrate-board space 340. In FIG. 3 and FIG. 5, the coordinate areas 341˜349 of the substrate-board space 340 in FIG. 3 correspond to the coordinate areas 251˜259 of the keep-out area 250 in FIG. 5 respectively. At this point, according to the detecting interference sequence set by users, the processing unit 111 may detect whether the corresponding heights H41˜H49 of each coordinate area 341˜349 in the substrate-board space 340 are lower than the heights set for each of the limited height areas 51˜59. However if one of the corresponding heights H41˜H49 is lower than the height set for the limited height areas 51˜59, the processing unit 111 determines that interference occurs between the circuit board 230 and substrate-board space 340. For example, as showing in FIG. 3 and FIG. 5, each height H41˜H49 of the coordinate areas 341˜349 are higher than the heights individually set for the limited height areas 51˜59. Therefore, the processing unit 111 determines that no interferences between the keep-out areas 250 and the substrate-board space 340, that is no interferences are generated when the circuit board 230 is disposed in the substrate-board space 340.

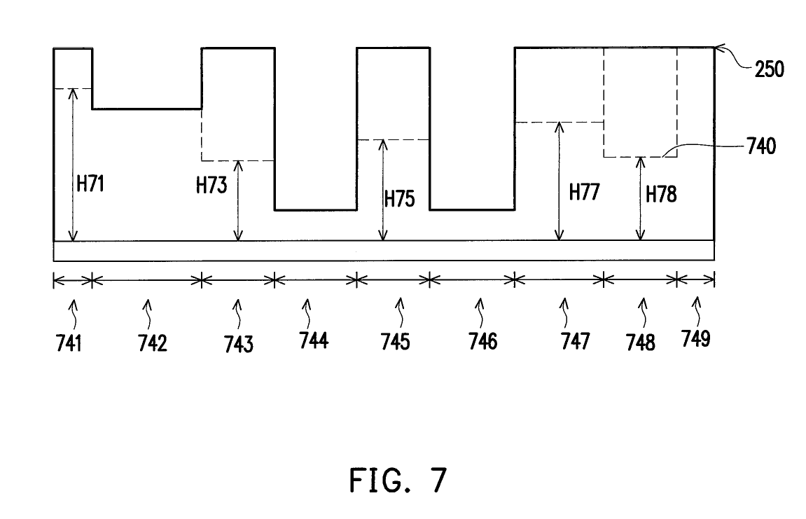

FIG. 7 is a diagram illustrating the method of detecting interference according to an embodiment of the present invention. Referring to FIG. 7 and FIG. 5, the coordinate areas 741˜749 in the substrate-board space 740 (represented with dotted lines) correspond to the coordinate areas 251˜259 of the keep-out area 250 (represented with solid lines) respectively. In FIG. 7, the corresponding heights H71, H73, H75, H77, and H78 of the coordinate areas 741, 743, 745, 747, and 748 are lower than the corresponding heights of the keep-out area 250. Therefore, the processing unit 111 determines that interferences are generated when the circuit board 230 is disposed in the substrate-board space 740.

Furthermore, the display unit 115 may display the substrate-board space 740 and the keep-out area 250 on the graphical interface. Therefore, users may easily check for the interferences generated between the substrate-board space 740 and the keep-out area 250 corresponding to the circuit board 230. In addition, an fault information may be prompted when the processing unit 111 determines that interferences are generated between the substrate-board space 740 and the circuit board 230. As a result, the processing unit 111 may simulate the disposition of the substrate-board space 740 and keep-out area 250 in the graphical interface for any substrate-board spaces, and may determine whether the substrate-board space interferes with the keep-out area 250.

In summary, the method for detecting interference in space is provided in the embodiments of the present invention. The electronic device may establish the keep-out area of the circuit board according to the first height limit and the plurality of second height limits of the circuit board. Wherein, if the target coordinate area of the circuit board has the second height limit, the limited height of the keep-out area which the target coordinate area corresponds to is the second height limit. If the target coordinate area does not have the second height limit, the limited height of the keep-out area which the target coordinate area corresponds to is the first height limit. Furthermore, the electronic device may compare the corresponding heights of each of the coordinate areas in a substrate-board space according to the keep-out area, and may determine whether the keep-out area interferes with the substrate-board space. In addition, the electronic device may prompt an fault information when the keep-out area interferes with substrate-board space.

As a result, when users want to perform interference and/or clash inspections between the spatial structure of the circuit board (i.e. motherboard) and the substrate-board space, a keep-out area may be established through the coordinate areas and the height limits which are partitioned by the electronic components of the circuit board. The keep-out area is then utilized to compare with the substrate-board space of the circuit board. Whereby, inspection may be performed for whether interferences and/or spatial clash have occurred.

Although the present invention has been described with reference to the above embodiments, however, the present invention is not limited thereto. It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method for detecting interference in spatial structure, comprising:
obtaining a circuit board, wherein the circuit board is set with a first height limit, and parts of a plurality of the coordinate areas in the circuit board are set with a plurality of second height limits respectively, wherein the second height limits are smaller than or equal to the first height limit;
establishing a keep-out area of the circuit board, according to the second height limits of the coordinate areas and the first height limit;
comparing the corresponding height of each coordinate area in a substrate-board space according to the keep-out area to simulate and determine whether interference occurs when the circuit board is disposed in the substrate-board space.

2. The method for detecting interference in spatial structure as claimed in claim 1, wherein the keep-out area comprises a plurality of limited height areas, each of the limited height areas corresponds to each of the coordinate areas in the circuit board, and,
the establishing of the keep-out area of the circuit board according to the second height limits of the coordinate areas and the first height limit comprises the following steps:
determining whether each of the coordinate areas in the circuit board has one of the second height limits correspondingly;
when a target coordinate area is set to a corresponding second height limit, each of the limited height areas corresponding to the target coordinate area is set to the second height limit; and
when a target coordinate area is not set to a corresponding second height limit, each of the limited height areas corresponding to the target coordinate area is set to the first height limit.

3. The method for detecting interference in spatial structure as claimed in claim 1, the comparison of the corresponding height of each coordinate area in the substrate-board space according to the keep-out area comprises the following steps:
determining the height set for each limited height area in the keep-out area and the height of the corresponding coordinate area of the substrate-board space sequentially.

4. The method for detecting interference in spatial structure as claimed in claim 1, the simulation and determination of whether interference occurs when the circuit board is disposed in the substrate-board space comprises the following steps:
when the corresponding height of each coordinate area in the substrate-board space is lower than the keep-out area corresponding to the coordinate area, determining that the substrate-board space interferes with the circuit board, and prompting a fault information.

5. The method for detecting interference in spatial structure as claimed in claim 1, wherein the substrate-board space is generated by the formation of a plurality of mechanism components.

6. The method for detecting interference in spatial structure as claimed in claim 1, further comprising:
providing a graphical interface to display the keep-out area and the substrate-board space.

7. The method for detecting interference in spatial structure as claimed in claim 1, further comprising:
obtaining the first height limit and the second height limits corresponding to the coordinate areas according to a first specification list of the circuit board.

8. The method for detecting interference in spatial structure as claimed in claim 1, further comprising:
obtaining the coordinate areas of the substrate-board space according to a second specification list of the substrate-board space.
